(19) United States
(12) Patent Application Publication
(10) Pub. No.: US 2012/0013928 A1
(43) Pub. Date: Jan. 19, 2012

(54) IMAGE FORMING APPARATUS

(75) Inventors: Mayuko YOSHIDA, Osaka (JP); Shinsaku TOHKI, Osaka (JP)

(73) Assignee: SHARP KABUSHIKI KAISHA, Osaka (JP)

(21) Appl. No.: 13/165,855

(22) Filed: Jun. 22, 2011

(30) Foreign Application Priority Data
Jul. 15, 2010 (JP) 2010-160786

(51) Int. Cl. G06K 15/02

(52) U.S. Cl. 358/1.13

(57) ABSTRACT

An image forming apparatus includes a document reader, a storage for storing image data, a display image generator for generating a display image, a display panel and a control unit-side controller for giving display guidance on the input status of image data from the document reader, on the display panel. The display panel includes a first display area and a second display area. The control unit-side controller performs control such as to display a display image in the first display area, move the display image displayed in the first display area toward the second display area, and then display the moved one in the second display area.

This Nonprovisional application claims priority under 35 U.S.C. §119 (a) on Patent Application No. 2010-160786 filed in Japan on 15 Jul. 2010, the entire contents of which are hereby incorporated by reference.

### BACKGROUND OF THE INVENTION

(1) Field of the Invention

The present invention relates to an image forming apparatus such as a copier, printer, facsimile machine or the like, in particular, relating to an image forming apparatus equipped with an image display control device capable of displaying plural pages of document images in preview representation.

(2) Description of the Prior Art

Recently, there have been known image forming apparatus that include an image display control device capable of multiple pages of document images in a preview representation. In such image forming apparatus, it is possible to confirm the documents that have been scanned before printout by displaying the processed result of the scanned (pre-scanned) documents before execution of a job.

As a prior art example, there has been disclosed a configuration of an image forming apparatus including display processing means that displays setting items for image processing and preview information showing the scheme of the image processing result on the same screen of a display means, so as to display preview information on the display means (see Patent Document 1).

According to the above image forming apparatus, when the pre-scan button is selected, a document is scanned (pre-scanned) in advance before the start of the job so that the preview of the processed result can be confirmed on the screen. Then, when the cancel button is selected, the pre-scanning is canceled and the display mode returns to the original state. When the OK button is selected, the display mode transits to a job execution state that displays a preview image using the pre-scanned document image. In this case, when the OK button is selected, the pre-scanned image is stored in RAM (Random Access Memory) or the like, and the stored information is handed over to the next screen. When multiple pages of documents have been scanned, arrow buttons are used to check the preview images of pages before and behind.

As another example of technology, there has been disclosed a configuration of an image processing apparatus including an animation display means that displays functions such as reading, reception, transmission and printing of images, by animation, so as to display the current function being executed by the image processed apparatus, in an animation representation (see Patent Document 2).

According to the above image processing apparatus, it is determined whether a pre-scanning copy (pre-scan operation) is in progress, and if it is determined that pre-scanning is being implemented, an animated picture is displayed on a UI device (user interface device). That is, an animated picture is displayed on a UI device having an animation display screen. This animated picture represents the image processing apparatus itself. Specifically, the animation presents an action in which document objects representing documents are taken into an apparatus object, and the images change in such a manner that document objects successively enter the scanning unit of the apparatus object, and the display of the animated picture is repeated during pre-scanning.

In this way, it is possible for the user to readily confirm the processing status of the image processing apparatus by displaying the function in progress in the image processing apparatus, in an animation representation.

### Patent Document 1:

Japanese Patent Application Laid-open 2007-221729

### Patent Document 2:

Japanese Patent Application Laid-open 2003-125125

However, the technology described in Patent Document 1 entails the problem that the user cannot grasp the status during scanning since no display of the progress of scanning is given when documents are pre-scanned.

On the other hand, the technology described in Patent Document 2 can inform the user of the function that is being executed in the image processing apparatus, but no display of the progress of scanning when documents are pre-scanned are displayed, similarly to the technology in Patent Document 1. Accordingly, the user cannot grasp the status during scanning, it hence is difficult to improve operativity.

### SUMMARY OF THE INVENTION

The present invention has been devised in view of the above prior art problems, it is therefore an object of the present invention to provide an image forming apparatus that is improved in operativity by enabling the user to visually check the progress of scanning on a display screen when documents are pre-scanned.

The first aspect of the invention resides in an image forming apparatus comprising: an input unit receiving image data; a storing unit storing the image data input from the input unit; a display image generator generating a display image based on the image data stored in the storing unit; a display unit displaying the display image generated by the display image generator; and a display controller for giving guidance on the input status of the image data input from the input unit, on the display unit, and is characterized in that the display unit includes: a first display area that displays the display image generated by the display image generator; and a second display area that displays the display image that was displayed in the first display area after display thereof in the first display area, and the display controller performs control so as to display the display image in the first display area when the display image is generated by the display image generator, and performs control so as to move the display image that was displayed in the first display area, toward the second display area and then display the display image in the second display area.

The second aspect of the present invention resides in that the display unit includes a preview display region that displays the finished state of the image based on the image data in a preview representation, as the display image, and the second display area is formed within the preview display region.

The third aspect of the present invention resides in that the display controller performs control so that when the display image is displayed in the first display area, the display image becomes gradually clearer (stepwise) toward the second display area and so that when the display image that was displayed in the first display area is moved to the second display area, the display image that is depicted clearly is displayed whilst it is being moved.

Here, the display controller may be designed to perform such control as to gradually enlarge the display image from small to large size, gradually change the display image from thin to dark density, gradually change the display image from blurred to clear display, or gradually display the display image from a state with less part displayed to the normal state.

The fourth aspect of the present invention resides in that the display controller displays a border line (e.g., displays a green line as a reading line) at the boundary between the first display area and the second display area and performs control such that when the display image that was displayed in the first display area is moved toward the second display area, the display image is moved passing over the border line.

The fifth aspect of the present invention resides in that the input unit is a scanner portion that reads the image of a document to output the image data, and, the display controller gives guidance on the input status of reading the document images, on the display unit when the display images have been generated based on the scanned image data of the documents read by the scanner unit.

The sixth aspect of the present invention resides in that the display unit includes a command control portion that enables the user to designate the function settings in image forming of the documents displayed as the display image on the display unit, and makes the command control portion (e.g., function selecting region) appear near the display image when display of the input status of the image data by the display controller has been completed.

The seventh aspect of the present invention resides in that the display unit displays the preview display region in an enlarged size when input of the image data is commanded.

The eighth aspect of the present invention resides in that the display unit has a control key region (e.g., task trigger region) including control keys (e.g., so-called task trigger keys such as scan-in key, monochrome start key, color start key, clear-all key, etc.) associated with the operation of the apparatus, and the control key region will not be reduced in size when the preview display region is displayed in an enlarged size.

The ninth aspect of the present invention resides in the border line and the control key region are laid out closely to each other in the display unit.

The tenth aspect of the present invention resides in an interrupt key for interrupting the operation of the apparatus is provided in the control key region of the display unit.

According to the first aspect of the present invention, it is possible for the user to visually confirm that image data is being captured by the apparatus, by displaying the input status of image data when the image data is input to the apparatus.

According to the second aspect of the present invention, the user is able to visually confirm that image data is being captured by the apparatus, by using an animated display picture that shows the display image of image data being moved toward the preview display region.

According to the third aspect of the present invention, the user is able to visually confirm the progress of reading of image data from the start to the end, by gradually changing the display image from small to large size, by gradually changing the display image from thin to dark density, by gradually changing the display image from blurred to clear display, or by displaying the display image from a state with less part displayed to the normal state. Accordingly, it is possible to grasp the input status more clearly.

According to the fourth aspect of the present invention, the user can grasp the input status of images more clearly by displaying the display image passing over the border line.

According to the fifth aspect of the present invention, it is possible to readily confirm the reading status of the scanner portion.

According to the sixth aspect of the present invention, it is possible to readily perform function settings by the command control portion that appears when input of image data (scan-in) is completed.

According to the seventh aspect of the present invention, it is possible to display the progress of the preview image being drawing into the preview display region conspicuously.

According to the eighth aspect of the present invention, since the user can give a command immediately when the user wants to give some operation instructions, it is possible to improve operativity.

According to the ninth aspect of the present invention, since the user can give a command immediately when the user wants to give some operation instructions, it is possible to improve operativity.

According to the tenth aspect of the present invention, since the user can give a stop command immediately when the user wants to interrupt reading of documents, for example, it is possible to improve operativity.

### BRIEF DESCRIPTION OF THE DRAWINGS

FIG. 1 is an illustrative view showing an overall configuration of an image forming apparatus according to the embodiment of the present invention;

FIG. 2 is an illustrative view schematically showing the internal mechanisms of the image forming apparatus;

FIG. 3 is a functional block diagram showing a hardware configuration of the image forming apparatus;

FIG. 4 is an illustrative view showing display regions on a touch panel display of the image forming apparatus;

FIG. 5 is an illustrative view showing a screen example displayed on the touch panel display;

FIG. 6 is an illustrative view showing a state where the preview region being displayed on the touch panel display is changed;

FIG. 7 is an illustrative view showing a display mode of a display panel of the touch panel display;

FIG. 8 is an illustrative view showing one example of a display mode of a preview display region in the touch panel display;

FIG. 9 is a block diagram showing an electric configuration of a control unit in the image forming apparatus;

FIG. 10 is a block diagram showing a configuration of the touch panel display of the control unit;

FIG. 11 is an illustrative view showing a display mode of the touch panel display at the time of document reading;

FIG. 12 is an illustrative view showing a displayed state on the touch panel display at the start of document reading;

FIG. 13 is an illustrative view showing a state where the image of the first document is displayed in the first display area on the touch panel display;

FIG. 14 is an illustrative view showing a state where the first sheet image is moving from the first display area to the second display area on the touch panel display;

FIG. 15 is an illustrative view showing a state where the second sheet image is displayed in the first display area after the first sheet image has been moved from the first display area to the second display area on the touch panel display;

FIG. 16 is an illustrative view showing a state where the second sheet image is moving from the first display area to the second display area on the touch panel display;

FIG. 17 is an illustrative view showing a state where the second sheet image has moved to and behind the first sheet image in the second display area on the touch panel display;

FIG. 18 is an illustrative view showing a state where the third sheet image has moved to and behind the second sheet image that moved and is displayed in the second display area on the touch panel display;

FIG. 19 is an illustrative view showing a displayed state of the touch panel display immediately after all the documents have been pre-scanned by scan-in in the image forming apparatus;

FIG. 20 is an illustrative view showing a displayed state of the touch panel display in instruction waiting mode after all the documents were pre-scanned by scan-in in the image forming apparatus;

FIG. 21 is an illustrative view showing a variational example 1 of a display mode of the touch panel display in the image forming apparatus of the present embodiment;

FIG. 22 is an illustrative view showing a variational example 2 of a display mode of the touch panel display; and,

FIG. 23 is an illustrative view showing a variational example 3 of a display mode of the touch panel display.

### DESCRIPTION OF THE PREFERRED EMBODIMENTS

The embodiment of the present invention will hereinafter be described with reference to the accompanying drawings.

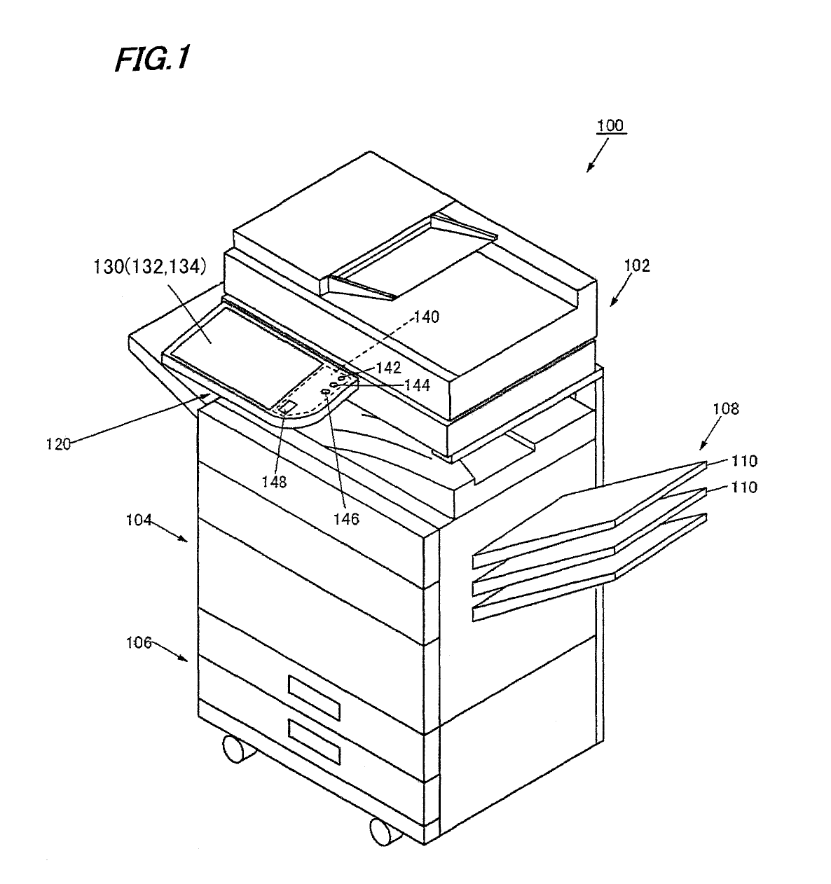

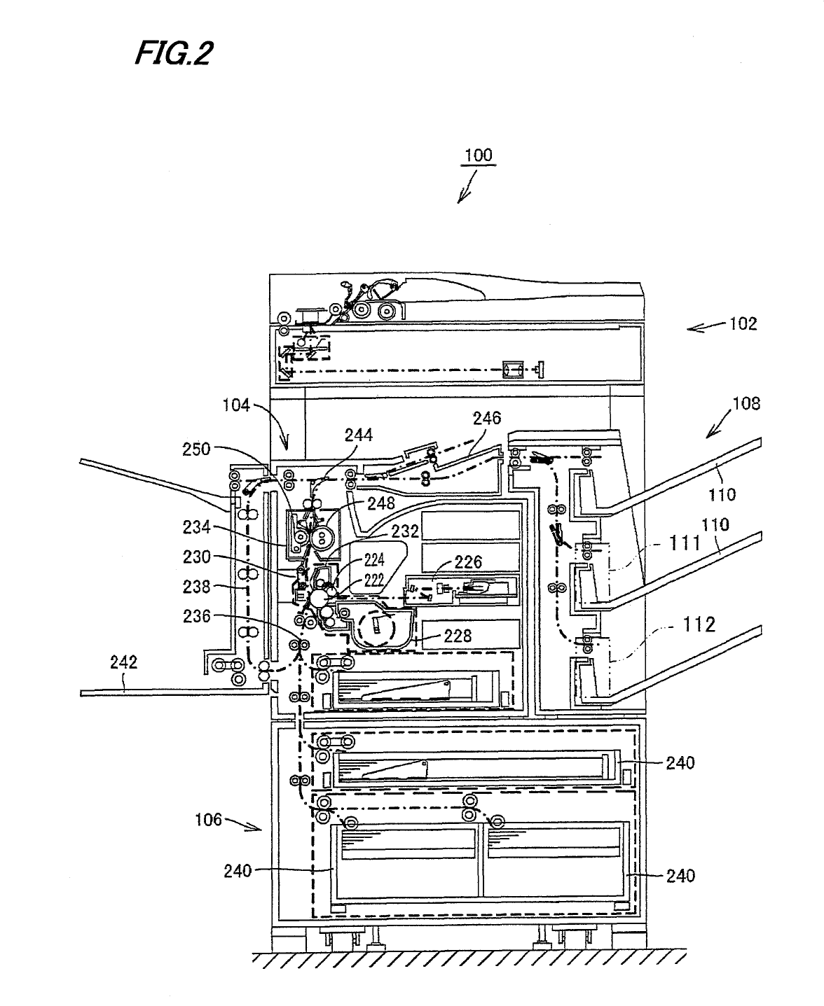

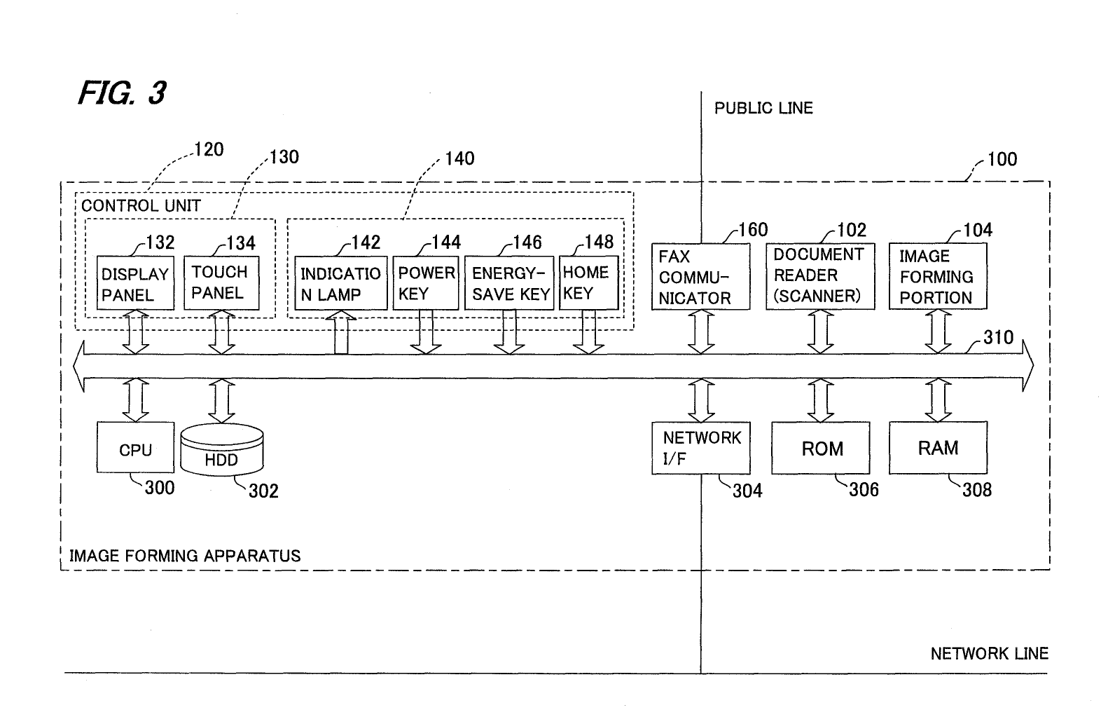

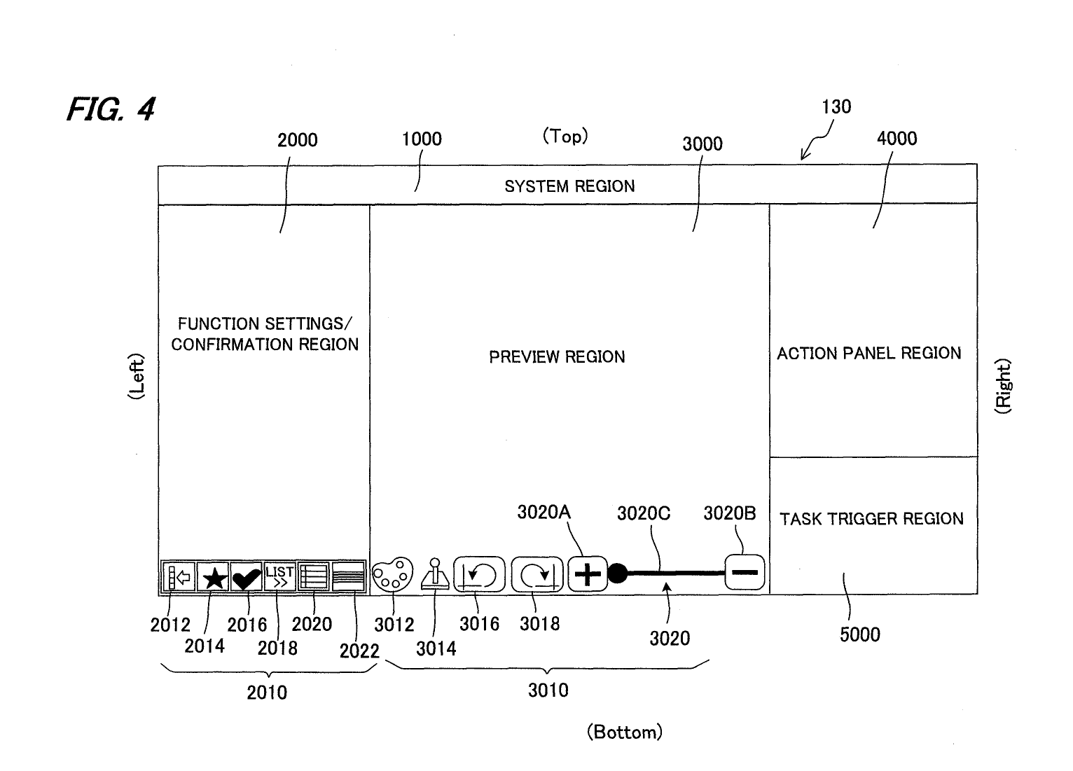

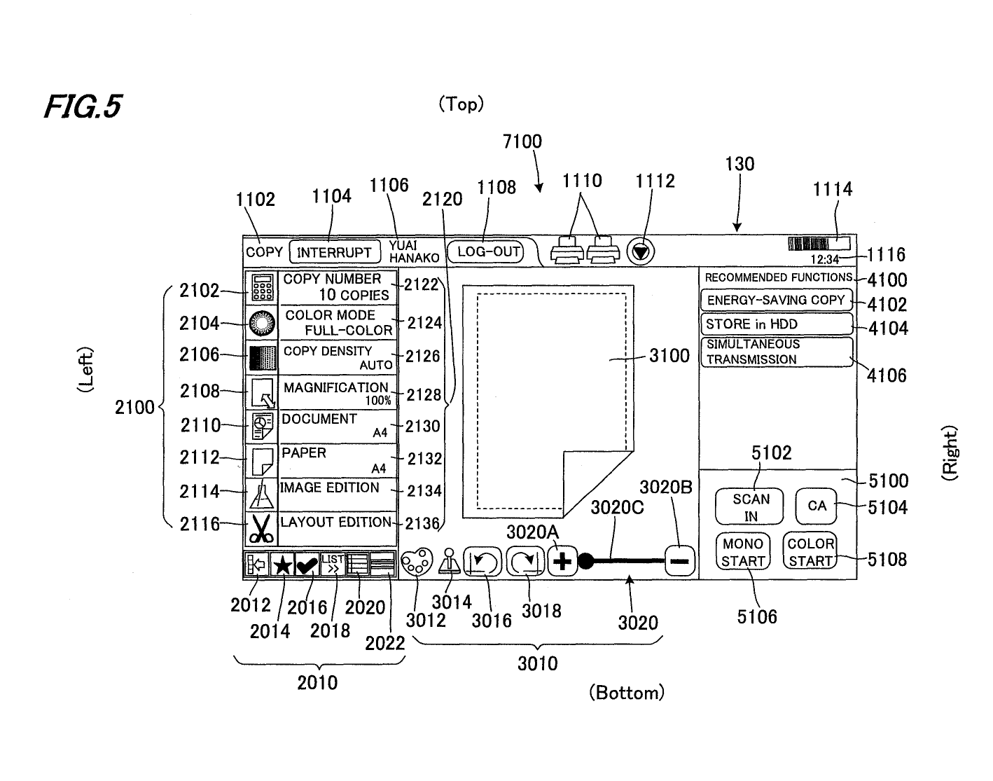

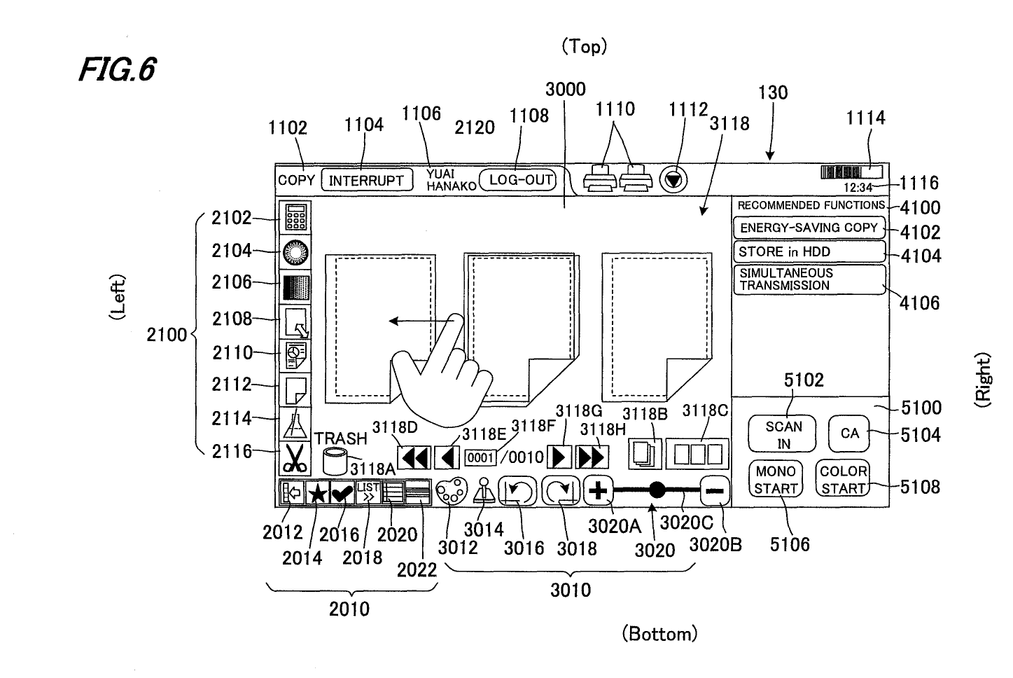

FIG. 1 is an illustrative view of one example mode of carrying out the present invention, showing an overall configuration of an image forming apparatus according to the embodiment of the present invention. FIG. 2 is an illustrative view schematically showing the internal mechanisms of the image forming apparatus. FIG. 3 is a functional block diagram showing a hardware configuration of the image forming apparatus. FIG. 4 is an illustrative view showing a preview display region on a touch panel display of the image forming apparatus. FIG. 5 is an illustrative view showing a screen example displayed on the touch panel display. FIG. 6 is an illustrative view showing a state where the preview region being displayed on the touch panel display is modified.

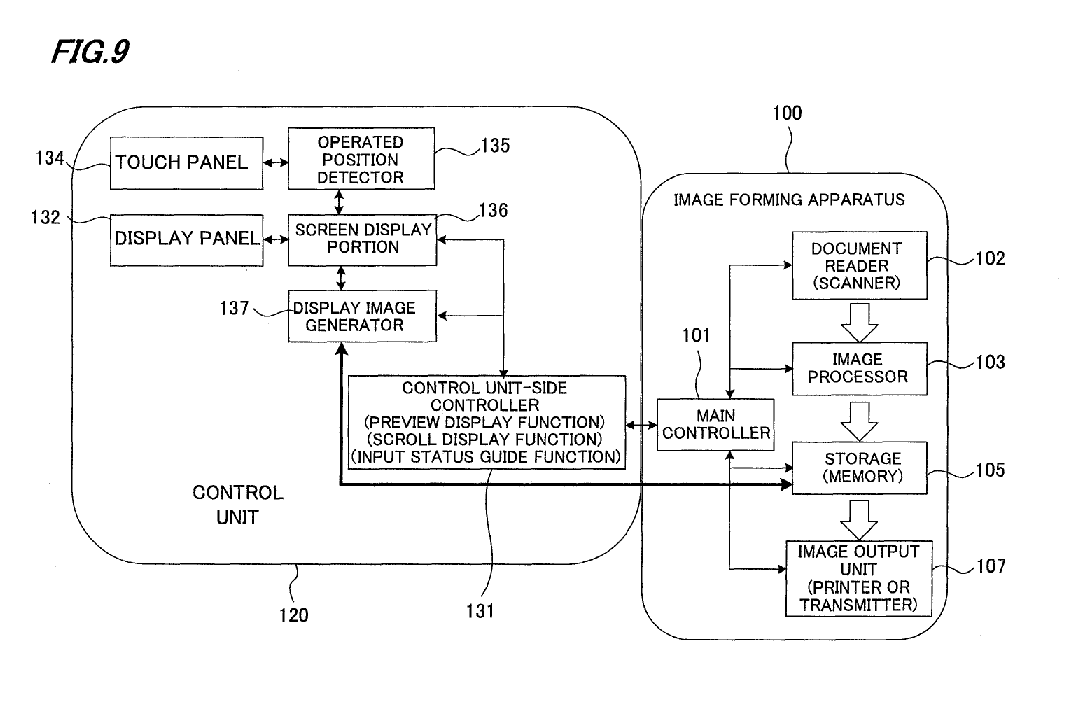

An image forming apparatus 100 according to the embodiment of the present invention includes, as shown in FIG. 1, includes: a document reader (input unit) 102 for capturing image data; an image forming portion 104 for forming an image on a recording medium based on the image data input through document reader 102; and a control unit (image display control device) 120 having a display panel (display portion) 132 for displaying preview images based on image data and a control unit-side controller (display controller) 131 (see FIG. 9) for displaying the input status of image data input from document reader 102, in a guidance representation on display panel 132.

The multiple document images displayed on display panel 132 may include preview display images of document images captured by the document reader etc., of image forming apparatus 100 and finished preview images of images formed on recording paper by the image forming portion.

Image forming apparatus 100 is a kind of an image processing apparatus. The image display control device according to the present invention is also applicable to image processing apparatus and electronic appliances other than the image forming apparatus of this kind.

Further, image forming apparatus 100 includes a plurality of operational modes, and is equipped with a display device for displaying information for each operational mode. The display device is preferably constructed so as to be able to display information the user wants in a user friendly manner even if the user does not remember the screen configuration when the operational mode is changed over.

Here, image forming apparatus 100 includes a touch panel display (control screen) that can be controlled by both gesture control and touch control other than gesture control, but the image forming apparatus may use a touch panel display that can be controlled by touch control only. Alternatively, the image forming apparatus may include a display panel that cannot be touch-controlled but can display only, with keys for control.

Here, gesture control means controls that are related to various kinds of movements of fingers in combination with GUI (Graphic User Interface), such as responses in accordance with the distance moved and speed of the fingers, double-tapping, the moving fingers trace and the like that are given with meanings.

This image forming apparatus 100 forms images on recording paper based on electrophotography.

Image forming apparatus 100 includes, as its operation modes, copy mode, facsimile mode (FAX mode), document filing mode (a mode in which scanned images are stored in a storage inside the image forming apparatus) and mail mode (a mode in which scanned images are transmitted in the form of an attachment file to an e-mail). This image forming apparatus 100 may further have a network printer mode.

The image forming apparatus 100 changes the display content on the screen every time the operation mode is switched. Further, the printing mechanism is not limited t electrophotography.

To begin with, image forming apparatus 100 will be described.

Image forming apparatus 100 of the present embodiment includes document reader 102, image forming portion 104, a paper feed portion 106, a paper output processor 108 and a control unit 120, as shown in FIG. 1.

Control unit 120 is formed of a touch panel display 130 and a display control portion 140. Touch panel display 130 is comprised of a display panel 132 of a liquid crystal panel or the like and a touch panel (touch control detecting means) 134 that is laid over display panel 132 to detect the positions the user presses with fingers. Display control portion 140 includes an indication lamp 142, a power key 144, an energy-save key 146 and a home key 148 that resets the display content of touch panel display 130 to the home screen for operational mode selection.

In this way, image forming apparatus 100 has touch panel display 130 as a main control device and also has a display control portion 140 that includes the hardware keys and indication lamps. The keys (power key 144, energy-save key 146 and home key 148) on display control portion 140 are given as hardware buttons, in contrast to software buttons formed by touch panel display 130.

Note that image forming apparatus 100 should not be limited to that including display control portion 140 of this kind, but may be provided with touch panel display 130 only. That is, it will work as long as the initial screen of the selected operational mode can be actuated when the user selects an operational mode on the home screen displayed on touch panel display 130. Next, the operational modes of this image forming apparatus 100 will be described.

### (Copy Mode)

The operation of the copy mode of image forming apparatus 100 will be described.

In this copy mode, image reader (which will be referred to hereinbelow as “scanner”) 102 and image forming portion 104 operate mainly.

A document placed on a document placement table is read as image data by scanner 102 and the read image data is input to a CPU 300 of a microcomputer etc. shown in FIG. 3, where the image data undergoes various kinds of image processing, and the processed image data is output to image forming portion 104.

As shown in FIG. 2, image forming portion 104 is a mechanism that prints images of documents given as image data onto recording mediums (recording paper in most cases), including a photoreceptor drum 222, a charging device 224, a laser scan unit (which will be referred to hereinbelow as “LSU”) 226, a developing device 228, a transfer device 230, a cleaning unit 232, a fixing unit 234, an unillustrated charge eraser and other devices.

Also, image forming portion 104 is provided with a main feed path 236 and a reverse feed path 238. The recording paper fed from paper feed portion 106 is conveyed along main feed path 236. Paper feed portion 106 draws recording paper, one sheet at a time, from a stack of recording paper, held in a paper feed cassette 240 or set on a manual feed tray 242 and delivers the recoding paper to main feed path 236 of image forming portion 104.

In the course of the recording paper being conveyed along main feed path 236 of image forming portion 104, the recording paper passes through and between photoreceptor drum 222 and transfer device 230 and then passes through fixing device 234 to perform printing for the recording paper.

While photoreceptor drum 222 rotates in one direction, its surface is cleaned by cleaning device 232 and the charge erasing device, then uniformly electrified by charging device 224.

LSU 226 modulates the laser beam based on the image data to be printed and repeatedly scans the laser beam over the photoreceptor drum 222 surface in the main scan direction, to form an electrostatic latent image on the photoreceptor drum 222 surface.

Developing unit 228 supplies toner to the photoreceptor drum 222 surface and develops the electrostatic latent image to form a toner image on the photoreceptor drum 222 surface.

Transfer device 230 transfers the toner image on the photoreceptor drum 222 surface to the recording paper which passes through the nip between the transfer device 230 and photoreceptor drum 222.

Fixing device 234 includes a heat roller 248 for heating recording paper and a pressing roller 250 for pressing recording paper. The recording paper is heated by heat roller 248 and pressed by pressing roller 250 so that the toner image transferred to the recording paper is fixed to the recording paper. A heater in the heat roller is heated by the power supplied to this fixing unit 234 so as to control and keep heat roller 248 at a temperature suitable for fixing. When the apparatus enters the energy saving mode, for instance the power supplied to this heater is stopped or cut down.

Arranged at the junction between main feed path 236 and reverse feed path 238 is a branch claw 244. When printing is performed on one side of recording paper only, branch claw 244 is positioned so as to lead the recording paper from fixing device 234 toward a paper output tray 246 or paper output processor 108.

When printing is performed on both sides of recording paper, branch claw 244 is rotated in the predetermined direction so that the recording paper is once conveyed toward the paper output tray 246 side. Then, the paper is switched back and conveyed toward reverse feed path 238. The recording paper then passes through reverse feed path 238 and is inverted upside down and fed to main feed path 236 again. The recording paper is once again printed on its rear side in the course of main feed path 236 and lead to paper output tray 246 or paper output processor 108.

The recording paper thus printed is lead to paper output tray 246 or paper output processor 108 and discharged to either paper output tray 246 or each of paper output trays 110 of paper output processor 108.

In paper output processor 108, a plurality of recording sheets are sorted and discharged to individual paper output trays 110, and/or each set of recording sheets is punched or stapled. For example, when multiple copies of printed documents are prepared, the printed recording sheets are sorted and discharged to paper output trays 110 so that one copy of the printed documents is allotted to individual paper output tray 110, and the printed documents on each paper output tray 110 are punched by a punching unit 111 or stapled by a stapling unit 112 to prepare individual printed material.

### (Facsimile Mode)

Next, the operation in facsimile mode will be described.

In this facsimile mode, the transmitting operation is mainly effected by document reader (scanner) 102 and a FAX communicator 160, as shown in FIG. 3. The receiving operation is mainly effected by FAX communicator 160 and image forming portion 104.

### (Transmitting Operation)

The transmitting operation is performed by the steps of: selecting the facsimile mode, reading image data from a document placed on the document placement table by means of document reader 102, supplying the read image data to CPU 300 made up of a microcomputer etc. shown in FIG. 3 where the image data is subjected to various kinds of image processes, and outputting the thus obtained image data to the FAX communicator (FAX communicator 160 in FIG. 3).

As shown in FIG. 3, FAX communicator 160 of the transmission side image forming apparatus 100 connects the selected transmitter side line to the designated destination, converts the image data into communication data conforming to the facsimile communication standard and transmits the communication data to the receiver side facsimile machine (e.g., image forming apparatus 100 having a facsimile function).

### (Communication Operation)

When connection of the line is established, FAX communicator 160 of image forming apparatus 100 on the receiver side detects a communication request signal from FAX communicator 160 of image forming apparatus 100 on the transmitter side and sends a response signal. Then, for example, FAX communicators 160 on both the transmitter and receiver sides exchange facsimile performance information of their own with each other and determine the communication rate and coding and code correction scheme of the image data within the available maximum capacity to set up a modem communication scheme. The data is transmitted based on the determined communication scheme, from FAX communicator 160 of image forming apparatus 100 on the transmitter side to FAX communicator 160 of image forming apparatus 100 on the receiver side. When data transmission is ended, the line is cut off.

### (Receiving Operation)

The FAX communicator 160 of image forming apparatus 100 on the receiver side converts the received data into image data and sends the data to image forming portion 104. Here, the received data may be converted into image data by image forming portion 104. Image forming portion 104 prints images of documents represented by the image data converted from the received data, onto recording paper, in the same manner as the above-described operation in copy mode.

Next, the control block configuration of image forming apparatus 100 will be described with reference to the drawings.

As shown in FIG. 3, image forming apparatus 100 includes: control unit 120 that allows the user to set copy mode and facsimile mode; a ROM 306 for storing programs etc.; a hard disk 302 serving as a non-volatile storage area that can hold programs, data and the like even if the power is cut off; and a RAM (Random Access Memory) 308 that offers a storing area when a program is executed.

Image forming apparatus 100 further includes: a bus 310 connected to image reader 102, image forming portion 104, FAX communicator 160, control unit 120, ROM 306, hard disk 302 and RAM 308; and CPU 300 that is connected to bus 310 to realize general functions as an image forming apparatus.

Hard disk 302 records (stores) files of image data of documents scanned by the image forming apparatus 100. Hard disk 302 also stores initial screen data for each operational mode. The files and data stored in hard disk 302 can also be recorded in ROM 306.

Stored in ROM 306 are programs, data and the like necessary for controlling the operation of image forming apparatus 100. As the data stored in ROM 306 with the programs, the initial screen data for each operational mode may be stored. CPU 300 controls image forming apparatus 100 in accordance with the programs and data stored in ROM 306 and performs control associated with each function of image forming apparatus 100.

As shown in FIG. 3, a public line for exchange of image data is connected to FAX communicator 160 of this image forming apparatus 100 while a network line is connected to a network interface 304. This network line may be connected to a computers etc. that use this image forming portion 100 as a network printer or may be connected via the Internet to a computer etc. that is identified by a designated URL (Uniform Resource Locator). When connected to the Internet in this way, the image forming apparatus 100 can obtain the necessary information via the Internet.

RAM 308 offers a function as a working memory for temporarily recording the result of the operation and processing by CPU 300 and a function as a frame memory for recording image data.

Control of image reader 102, image forming portion 104, touch panel display 130 and display control portion 140 forming control unit 120, ROM 306, hard disk 302 and RAM 308 is performed by CPU 300 executing predetermined programs. Here, control unit 120 communicates with CPU 300 by way of an input/output interface.

Control unit 120 is given as a board-like panel that is tilted so as to allow the user ease of view. Control unit 120 includes touch panel display 130 in the left area and display control portion 140 (including indication lamp 142 and hardware buttons, namely, power key 144, energy-save key 146 and home key 148) in the right area on the top thereof. Touch panel display 130 and display control portion 140 are integrally provided in control unit 120.

As described above, this touch panel display 130 is formed of display panel 132 and touch panel 134 that is laid over display panel 132.

Displayed on touch panel display 130 are the home screen for selection of the operational mode of image forming apparatus 100, the current status of this image forming apparatus 100, the status of destination selection, job processing status and the like.

Displayed in the preview display region of display panel 132 are selection buttons as software keys. When the displayed area of a selection button is pushed by a finger, touch panel 134 detects the pushed position. Then, the position on which touch panel 134 is pressed is compared with the positions of selection buttons so as to perform selection of an operational mode of image forming apparatus 100, functional setting, operational instructions, and the like. In addition to this touch control (command input control based on the position of the user's pressing), this image forming apparatus 100 also supports the above-mentioned gesture control (command input control based on the trace of user's control motion).

Further, indication lamp 142 of display control portion 140 is made up of a LED (Light Emitting Diode) for instance and is controlled by CPU 300 so as to turn on/off (/flash on and off). When the user presses down power key 144 that is provided separately in addition to the main power switch, this image forming apparatus 100 comes out of standby mode (in which, for example, only fax reception is permitted with the main power turned on) to active mode so that the whole operational modes of this image forming apparatus 100 can be used. Indication lamp 142 comes on in link with this status. Further, when a predetermined period has elapsed without receiving any user input, or when the user presses energy-save key 146, this image forming apparatus 100 comes out of active mode into energy save mode so that only part of the operational modes of image forming apparatus 100 are operational. Indication lamp 142 flashes on and off in link with this status. Further, when the user presses energy-save key 146 in this energy save mode, the image forming apparatus 100 comes out of energy save mode into active mode. Home key 148 is a hardware key for retuning the display of touch panel display 130 into the initial condition (home screen). It is noted that the operations when power key 144, energy-save key 146 and home key 148 are pressed should not be limited to these.

The hardware keys on display control portion 140 (power key 144, energy-save key 146 and home key 148) may be embedded with a key lamp controlled by CPU 300 so as to turn on/off(/flash). For example, this key lamp may be a round type key ring-like lighting or center lighting. This key lamp turns on at the timing that the hardware key is permitted to use as a control device (at the timing that operation is performed when the hardware key is used).

Image forming apparatus 100 has the aforementioned two operational modes (copy mode and facsimile mode). Software buttons for function settings in each operational mode are displayed on touch panel display 130, and also the preview as the on-screen form of forming images, keys for destination setting and the like are displayed as necessary.

When the operational mode is different from that which the user wants, touch panel display 130 displays another screen. Even in such a case, in order for the user to easily find the information the user requests, touch panel display 130 is divided into multiple regions (which also are given in a size variable manner) so as to display necessary information in each region.

In particular, in this image forming apparatus 100, when one operational mode is selected on the home screen of touch panel display 130 provided as the main display control device, the initial screen of the operational mode is displayed.

In this initial screen, (1) the basic layout is formed of five areas, namely “system region”, “function selecting region”, “preview region”, “action panel region” and “task trigger region”, which are appropriately arranged, so that the user is able to easily perform input of settings from top left to bottom right (in the same manner as the user moves their gaze and fingers in the conventional machine which is not provided with a large scale touch panel display 130). Further, (2) the concept of the displays of the five regions is consistent in all operational modes, so that the user is able to operate without confusion when another operational mode is used. The following description will be given on the configuration of the basic layout.

The basic layout in touch panel display 130 will be described with reference to the drawings.

As shown in FIG. 4, the basic layout of touch panel display 130 is designed in the laterally long touch panel display 130 such that a system region 1000 is arranged at the topmost part, a preview region (preview display region) 3000 in the center of the screen, a function settings/confirmation region 2000 on the left side of preview region 3000, an action panel region 4000 on the upper right part of preview region 3000, and a task trigger region (control key displayed region) 5000 on the lower right of preview region 3000. Here, the laterally long touch panel display 130 is formed of, for example, 1024 pixels wide×600 pixels high. Further, function settings/confirmation region 2000 will be written hereinbelow as function selecting region 2000.

It is noted that, the number of regions in touch panel display 130 should not be limited to five. Also, the horizontal arrangement should not be limited so that the horizontal arrangement may be reversed right side left, for example, depending on the user's dominant hand. Further, the position of system region 1000 may be disposed at the lowermost part. Alternatively, the system region 1000 may be undisplayed depending on the status or settings.

System region 1000 displays the current status of this image forming apparatus 100, e.g., the title of the operational mode in control and the status and conditions of image forming apparatus 100. For example, displayed in system region 1000 are the name of operational mode, the cut-in key, the log-in user name, the job status in progress, the usage status of built-in memory, time and the like.

In function selecting region 2000, settings in each function, display switching, function selecting menu (icons, buttons, etc.) operated by user to confirm settings are variably displayed in a selected display style, i.e., in icon mode, regular mode or express mode. In icon mode, only icons for function setting are displayed in function selecting region 2000 so as to maximize the size of preview region 3000. In express mode, the display of function selecting region 2000 is enlarged so as to allow the user to set the function all at once though the size of preview region 3000 is minimized. In regular mode, preview region 3000 is sized between that in the icon mode and that in the express mode while in function selecting region 2000 the text of function titles are displayed together with functional setting icons.

These icon mode, regular mode and express mode are switched from one to another based on user control. That is, the size of preview region 3000 is modified and displayed in accordance with user control. In this way, since icons are able to give information to the user by using limited area, it is preferable that every function is given with an icon so as to be able to enlarge the display of preview region 3000.

This function selecting region 2000 includes at its bottom a group of select buttons 2010 for switching the display style in function selecting region 2000. Arranged in the group of select buttons 2010 are an icon mode entering button 2012 for displaying function selecting region 2000 in icon mode, a favorite button 2014 for displaying the functions registered as “favorites”, a check button 2016 for displaying the functions whose settings have been modified, a list button 2018 for displaying a list of all the functions that can be designated in the selected operation mode, a regular mode entering button 2020 for displaying function selecting region 2000 in regular mode, and an express mode entering button 2022 for displaying function selecting region 2000 in express mode.

Here, when there are many pieces of information to be displayed in function selecting region 2000, the information is displayed in this function selecting region 2000, in a vertically movable manner. In this case, this group of select buttons 2010 is not moved but constantly displayed in the bottom-most portion of function selecting region 2000.

Preview region 3000 displays the image of the output pages of the (finished) document. The image is displayed using dummy data or scanned data, and the displayed image in preview region 3000 is revised every time the user changes the finish. There are two modes of displaying the finish in this preview region 3000: the display of the final preview with a dummy image in virtual mode before scanning and the display of the final preview with actual images in scan-in mode after scanning. The virtual mode further has two types, before setting documents and after setting documents.

At the bottom of this preview region 3000 there is a group of preview select buttons 3010 for changing the display style in preview region 3000. The group of preview select buttons 3010 includes a rotate-left button 3016 for rotating the image left 90 degrees and a rotate-right button 3018 for rotating the image right 90 degrees and a zoom bar 3020. Other than these, for example a change color button 3012 and preview control button 3014 are arranged.

With this, when rotate-left button 3016 is touched once, the preview rotates 90 degrees left. When the button is touched twice, the preview is rotated 180 degrees left (inverted upside down). Alternatively, when the image of the finished document displayed in the preview region is gesture-controlled (by rotating the document image 180 degrees counterclockwise with the fingertip), the preview is rotated 180 degrees left or inverted upside down.

When rotate-right button 3018 is touched once, the preview rotates 90 degrees right. When the button is touched twice, the preview is rotated 180 degrees right (inverted upside down). Alternatively, when the image of the finished document displayed in the preview region is gesture-controlled (by rotating the document image 180 degrees clockwise with the fingertip), the preview is rotated 180 degrees right or inverted upside down.

When the (+) button 3020A of zoom bar 3020 is touched, or when bar 3020C is gesture-controlled (by the “drag or flick” gesture) toward the (+) button 3020A, the preview image is enlarged. Alternatively, when the image of the finished document displayed in the preview region is gesture-controlled (on the document image by the “pinch out/pinch open” gesture with fingertips), the preview image is enlarged. Here, the “drag” gesture is an action of moving the finger. The “flick” gesture is a swiping action of the finger. The “pinch out/pinch open” is an action of spreading the two fingertips apart.

When the (−) button 3020B of zoom bar 3020 is touched, or when bar 3020C is gesture-controlled (by “drag or flick” gesture) toward the (−) button 3020B, the preview image is reduced. Alternatively, when the image of the finished document displayed in the preview region is gesture-controlled (on the document image by the “pinch in/pinch close” gesture with fingertips), the preview image is reduced. Here, the “pinch in/pinch close” is an action of bringing the two fingertips together.

When there are many pages of document images to be displayed in preview region 3000, touchable displayed page select buttons (page number input buttons, page up and down buttons, single page display button and multiple page display button, etc.) may be displayed. In this case, it is also possible to turn over or return the page of the document to be previewed by a sliding touch (flicking) of the document image. Further, when the document image to be displayed in preview region 3000 is large, scroll bars that can be touched or gesture-controlled may be displayed.

Action panel region 4000 displays information such as hint, advice and suggestion for operation and control. Display in this action panel region 4000 is given such that when a particular function is selected by a certain user, the functions associated with the subject function may be displayed, another function as to the subject function may be displayed in a purpose-oriented manner, or the function that was selected in the past in combination with the subject function by the same user or a user of the group to which this user belongs may be displayed as a “recommended function”.

Task trigger region 5000 displays trigger items that the user operates in order to actually cause the image forming apparatus 100 to operate after all the settings in the operational mode have been completed. An example is the start button (software button) for starting the operation. Here, since information on a lack of a consumable supply is also related to the unfeasibility of the task in the operational modes needing a printing process (other than fax transmission), this should be also displayed in this “task trigger region”.

In this case, it is also preferable that the start button is displayed only when the start button can be pressed down. The condition in which the start button can be pressed down, means a state where all settings have been completed and none of consumable supplies (recording paper and toner) will run short in the case of an operational mode needing a printing operation or a state where all the transmission parameters including destination have been set in the case of a fax mode (transmission) operation as the operational mode needing no printing.

The layout of these five regions is not changed even if the operational mode is switched from one to another (in the initial screen of any operational mode). Further, each region may change in size, expanding or contracting in the horizontal (longitudinal) direction of the screen of touch panel display 130 as in the case where the display of function selecting region 2000 (and preview region 3000) is switched between icon mode, regular mode and express mode.

The layout of the five regions is designed in light of the user interfaces in conventional machines, by directing attention to user's path of gaze and control. This arrangement leads the user to perform settings by moving their gaze from top left to bottom right and moving their input action (fingers of the dominant hand) from top left to bottom right.

In this arrangement, for switching the operational mode from one to another, the user presses down home key 148 (FIG. 3) and selects another operational mode on the home screen. In this way, it is possible to change operational mode by way of the home screen.

### (Initial Screen Display Operation in Copy Mode)

When copy mode is selected, the initial screen for copy mode is displayed on touch panel display 130 using copy mode initial screen data loaded from hard disk 302 (FIG. 3) or the like.

In this occasion, a copy mode initial screen 7100 is displayed for example, on touch panel display 130, as shown in FIG. 5. Copy mode initial screen 7100 displays information using the five divided regions laid out as described above.

In system region 1000 (FIG. 4) of copy mode initial screen 7100, areas 1102, 1104, 1106, 1108, 1110, 1112, 1114 and 1116 are laid out as shown in FIG. 5.

Area 1102 denotes the operational mode being selected (copy mode in this case). Displayed in area 1102 is the name and/or icon of the operational mode.

It is also preferred that a pulldown menu showing operational modes is displayed so as to allow for switching of operational mode when this area 1102 is touch-controlled, tapped or double-tapped (the same in other operational modes).

Area 1104 displays sub information entailing the selected operational mode.

In area 1104 a cut-in key (software button) is displayed as sub information. When this cut-in key is touch-controlled, tapped or double-tapped, a cut-in process can be actuated in copy mode.

Area 1106 displays the log-in user name.

In area 1108 a log-out button (software button) is displayed.

Area 1110 displays the status of the job in progress.

Area 1112 displays buttons (software buttons) related to job status.

That is, area 1112 displays the status of the job in progress with an icon. This job status is touch-controlled, tapped or double-tapped, the job status information is displayed in detail. It is further preferable that a button for suspending the selected job and the like is displayed in area 1112.

Area 1114 displays the communication status and area 1116 displays the current time.

Displayed in function selecting region 2000 (FIG. 4) on copy mode initial screen 7100 are a function selecting menu 2100 that allows the user to select in copy mode and a group of select buttons 2010 described above. In the screen shown in FIG. 5, the function select menu is displayed in regular mode.

As shown in FIG. 5, the function select menu displayed in regular mode is composed of a group of icons 2100 and a group of texts 2120. As the function select menu displayed in function selecting region 2000, texts 2122, 2124, 2126, 2128, 2130, 2132, 2134 and 2136 are displayed.

Text 2122 shows an icon 2102 for setting the number of copies and its set content.

Text 2124 shows an icon 2104 for setting color mode and its set content.

Text 2126 shows an icon 2106 for setting copy density and its set content.

Text 2128 shows an icon 2108 for setting copy magnification and its set content.

Text 2130 shows an icon 2110 for setting the document type and its set content.

Text 2132 shows an icon 2112 for setting the paper type and its set content.

Text 2134 shows an icon 2114 for image edition and its set content.

Text 2136 shows an icon 2116 for layout edition and its set content.

Here, it should be noted that a greater number of items can be also displayed in the function setting menu, in a vertically scrolling manner with the position of select buttons 2010 fixed. In this case, the displayed items in the function setting menu inclusive of hidden items above and below, can be changed from one to another by any of touch control (scroll control) and gesture control (flick control in the vertical direction).

Here, the image edition is edition for one page document, and includes, as a lower-layered menu, frame deletion, printing menu, watermark, user stamp and the like. The layout edition is edition for multiple pages of documents, and includes, as a lower-layered menu, page integration, binding margins, page change, centering and the like. Subordinates menus under these will be displayed on touch panel display 130 by touching, taping or double-tapping icons 2102 to 2116 or texts 2112 to 2136.

Arranged in preview region 3000 (FIG. 4) on copy mode initial screen 7100 are a document output (finish) image 3100 and a group of preview select buttons 3010 stated above. In this arrangement, dummy data or scanned data is used to display image 3100, and the image 3100 is changed and displayed in preview region 3000 every time the function setting menu in function selecting region 2000 is changed (the preview display is changed).

Displayed in action panel region 4000 (FIG. 4) on copy mode initial screen 7100 is information such as hint, advice and suggestion for copying operation. Here, recommended functions in the copy mode that the user selects are displayed as shown in FIG. 5. In this case, action panel region 4000 includes an area 4100 for displaying the content of displayed information and areas 4102 to 4106 that serve in themselves as software buttons and display text indicating recommended functions.

When area 4102 is touch-controlled, tapped or double-tapped, a pulldown menu of further detailed information for energy-saving in copying is displayed. In this case, for example a software button for entering the function setting screen for duplex copying is displayed with text “Duplex printing will save paper”, a software button for entering the function setting screen for page integration with text “Printing multiple documents integrally will save paper”, and a software button for entering the function setting screen for saddle stitch binding with text “Printing can be done so as to bind the paper as a booklet”.

Displayed in task trigger region 5000 (FIG. 4) on copy mode initial screen 7100 is a group of command buttons 5100. These command buttons 5100 include a scan-in key (software button) 5102, a clear-all key (software button) 5104, monochrome start key (software button) 5106 and a color start key (software button) 5108.

Scan-in key 5102 is a key for causing image forming apparatus 100 to scan a document to obtain image data.

Clear-all key 5104 is a key for clearing the set functions.

Monochrome start key 5106 is a key for causing image forming apparatus 100 to scan a document and perform monochrome copying.

Color start key 5108 is a key for causing image forming apparatus 100 to scan a document and perform color copying.

In this way, when the user inputs a request in copy mode initial screen 7100 displayed with information in five-divided regions, a copying process is effected in accordance with the request.

Next, description will be made on the switching operation of preview pages when preview region 3000 (FIG. 4) is enlarged with function selecting region 2000 (FIG. 4) displayed in icon mode.

When the user flicks left the preview display screen in which a preview image 3118 is displayed as shown in FIG. 6, the input trace is analyzed. In this case, the gesture control by this user is analyzed as a request for turning over the page, and a revised preview image including another page that has not been displayed and corresponds to the direction of the flick is displayed.

It is also possible to change the pages in preview image representation by touching a page forward button 3118G, page fast forward button 3118H, page reverse button 3118E or page fast reverse button 3118D. It is also possible to change the pages in preview image representation by touching a direct pagination button 3118F to directly input the page number the user wants to jump.

In this way, when function selecting region 2000 is displayed in icon mode, preview region 3000 is enlarged so that it is possible to display the preview image so as to improve user' visual recognition and user controllability, as shown in FIG. 6. In particular, it is possible to scroll the preview display up to a preview image the user wants by touch control or gesture control, and display the desired preview image.

Here, designated at 3118A in FIG. 6 is a trash icon. When a selected page is dragged to this trash icon 3118A, the page can be deleted.

When a single page display icon 3118B is pressed down, the preview image with, for example three pages displayed, is changed to one page representation (in this case one page is displayed in a large scale). When a multiple page display icon 3118C is pressed down, the preview image with, for example, one page displayed, is changed to three page representation.

Next, the display modes of touch panel display 130 will be described with reference to the drawings.

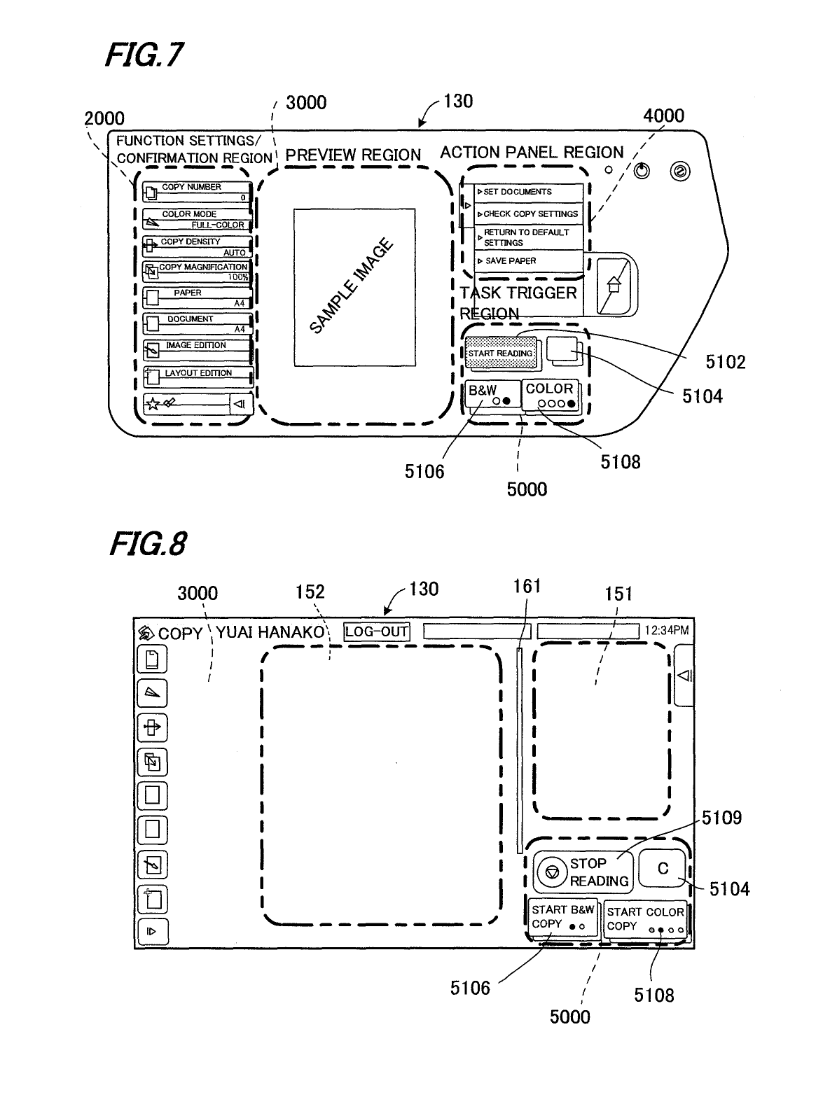

FIG. 7 is an illustrative view showing the first display mode of touch panel display 30. FIG. 8 is an illustrative view showing the second display mode of touch panel display 30.

As shown in FIG. 7, arranged on touch panel display 130 in the first display mode are preview region 3000 in the center of the screen and function selecting region 2000 on the left side of preview region 3000. Action panel region 4000 is laid out on the upper right of preview region 3000, and task trigger region 5000 is arranged under the action panel region 4000.

When scan-in key 5102 for starting scanning of documents, aftermentioned monochrome start key 5106 or color start key 5108 for starting image output is pressed in the first display mode shown in FIG. 7, the displayed information items in function selecting region 2000 and action panel region 4000 on touch panel display 130 are pulled in to both the left and right sides so as to enlarge preview region 3000, whereby the display state is changed to the second display mode shown in FIG. 8.

As, shown in FIG. 8, in touch panel display 130, preview region 3000 is enlarged so that a first display area 151 is formed at the position corresponding to action panel region 4000 and a second display area 152 greater than first display area 151 is formed in the approximate center in preview region 3000.

In first display area 151, a display image in its incomplete state, or in halfway of image generation based on the input image data is displayed so as to depict the page-wise scanning status of documents.

On the other hand, in second display area 152, a display image in its complete state of image generation based on the input image is displayed.

Then, in order to show the state of reading documents pagewise, the display image displayed in its incomplete state in first display area 151 is moved while its display content is being enlarged and its displayed position being shifted until the display image in its complete state is displayed in second display area 152. The progress in which the display image is moved from first display area 151 to second display area 152, may be rendered by depicting gradual enlargement, gradual clarifying of the display content, or in combination of these. Of course, the display image in its complete state may be displayed in first display area 151 as in the second display area 152.

First display area 151 and second display area 152 are arranged side by side.

A border line 161 that shows the boundary is displayed between first display area 151 and second display area 152.

Border line 161 is to schematically represent the status of documents being scanned by document reader 102, on touch panel display 130 in order to provide “screen display guidance” at the timing of document reading. That is, border line 161 can be regarded as document reader 102 on touch panel display 130. Accordingly, the display image in its incomplete state in first display area 151 slowly passes by border line 161 and reaches second display area 152 so that the display image in its complete state is displayed. Detailed specific examples of the screen guidance display at the time of document scanning will be described later. In the present embodiment, border line 161 is displayed as a linear green line extending in the vertical direction of touch panel display 130.

Task trigger region 5000 is constantly displayed near border line 161 in the lower right of preview region 3000 without reduction in size even when preview region 3000 is enlarged.

Displayed in task trigger region 5000 is a group of command buttons 5100. In the group of command buttons 5100, scan-in key 5102, clear-all key 5104, monochrome start key 5106 and color start key 5108 are laid out.

When this scan-in key 5102 is operated so as to scan documents and start acquisition of image data, the scan-in key is replaced by an interrupt key (control key) 5109 for interrupting the operation of apparatus (interrupting scanning), as shown in FIG. 8.

Next, the electric configuration related to the screen display of control unit 120 will be described with reference to the drawings.

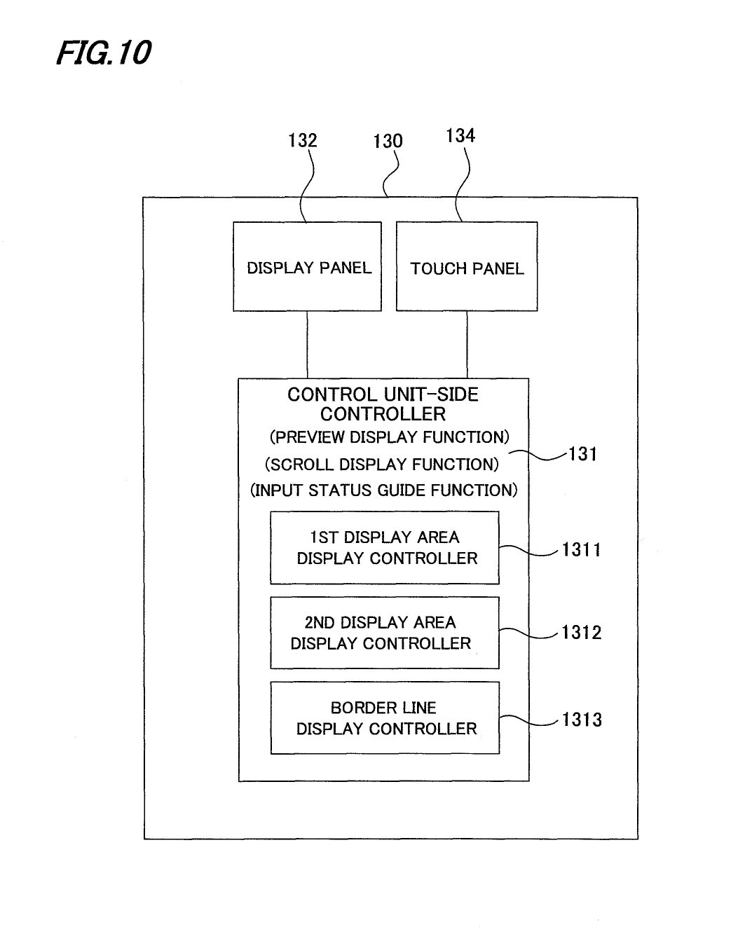

FIG. 9 is a block diagram showing the electric configuration of control unit 120. FIG. 10 is a block diagram showing the configuration of touch panel display 130 of control unit 120.

As shown in FIG. 9, control unit 120 includes, in addition to display panel 132 and touch panel 134, an operated position detector 135, a screen display portion 136, a display image generator 137 and control unit-side controller (display controller) 131 for controlling processing and operation in control unit 120.

Image forming apparatus 100 includes document reader 102 for capturing image data, an image processor 103, a storage 105 for storing image data input through document reader 102 and an image output unit 107 such as a printer, transmitter or the like for outputting images, all being operated and controlled by a main controller 101.

Operated position detector 135 detects the operated position on touch panel 134.

Screen display portion 136 displays an image formed by display image generator 137 on display panel 132.

Display image generator 137 prepares a predetermined image based on image data input to the main body of image forming apparatus 100, following instructions from control unit-side controller 131.

Control unit-side controller 131 is connected to main controller 101 of the main body of image forming apparatus 100 and functions as a controller in touch panel display 130.

Now, control unit-side controller 131 will be described in detail.

As shown in FIG. 10, control unit-side controller 131 provides a preview display function for displaying multiple pages of document images in a preview representation on display panel 132, a motion display function of displaying the preview images of multiple page document images while moving them, and an input status guiding function for displaying the input status of image data input through document reader 102 on display panel 132 to guide the user.

In order to achieve the above functions, control unit-side controller 131 includes a first display area displaying controller 1311, a second display area displaying controller 1312 and a border line displaying controller 1313.

First display area displaying controller 1311 performs control of displaying the display image generated by display image generator 137 on first display area 151.

Further, first display area displaying controller 1311 controls to display the display image in first display area 151 in such a manner that the image gradually becomes clear toward second display area 152.

Second display area displaying controller 1312 performs control of displaying the display image in second display area 152 after the display image in first display area 151 has been moved to second display area 152.

Further, when the display image displayed in first display area 151 is moved to second display area 152, second display area displaying controller 1312 performs control so as to display the display image in a clear condition while moving it.

Moreover, when the display image displayed in first display area 151 is moved toward second display area 152, second display area displaying controller 1312 performs control so as to display the display image passing over border line 161.

Border line displaying controller 1313 performs control of, displaying border line 161 that indicates the boundary between the display area (first display area 151) for virtually showing the state before image data is input to document reader 102 and the display area (second display area 152) for virtually showing the state after image data has been input to document reader 102.

Referring next to the drawings, the preview display given to performing guidance of the document reading status by document reader 102 on touch panel display 130 at the time of document reading will be described.

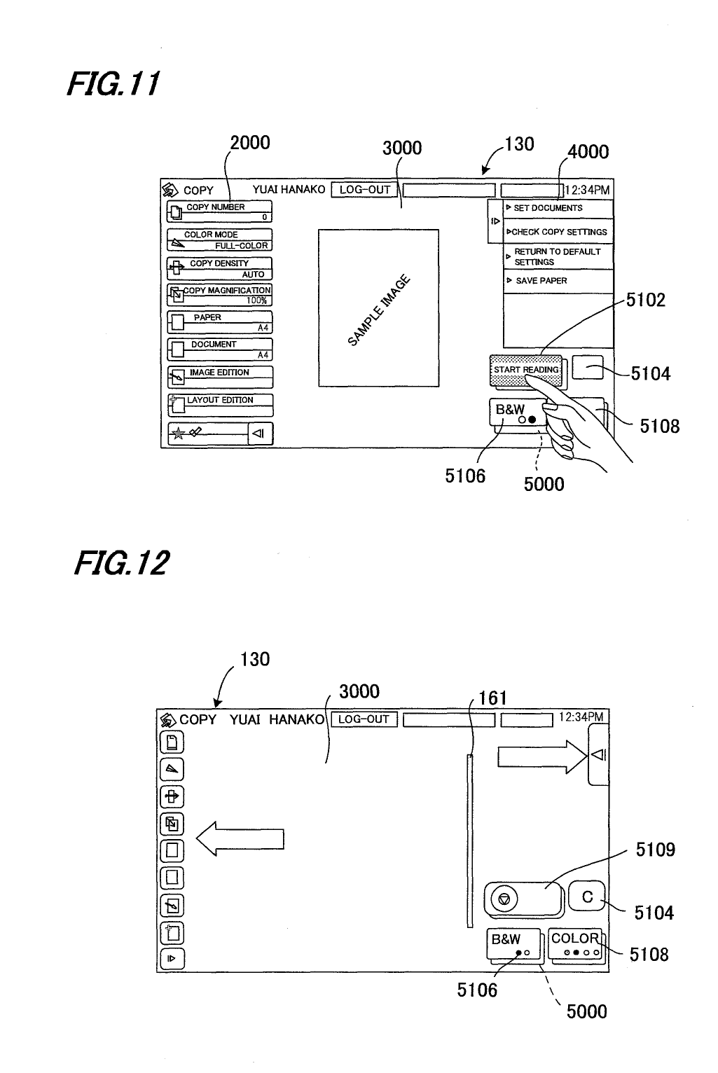

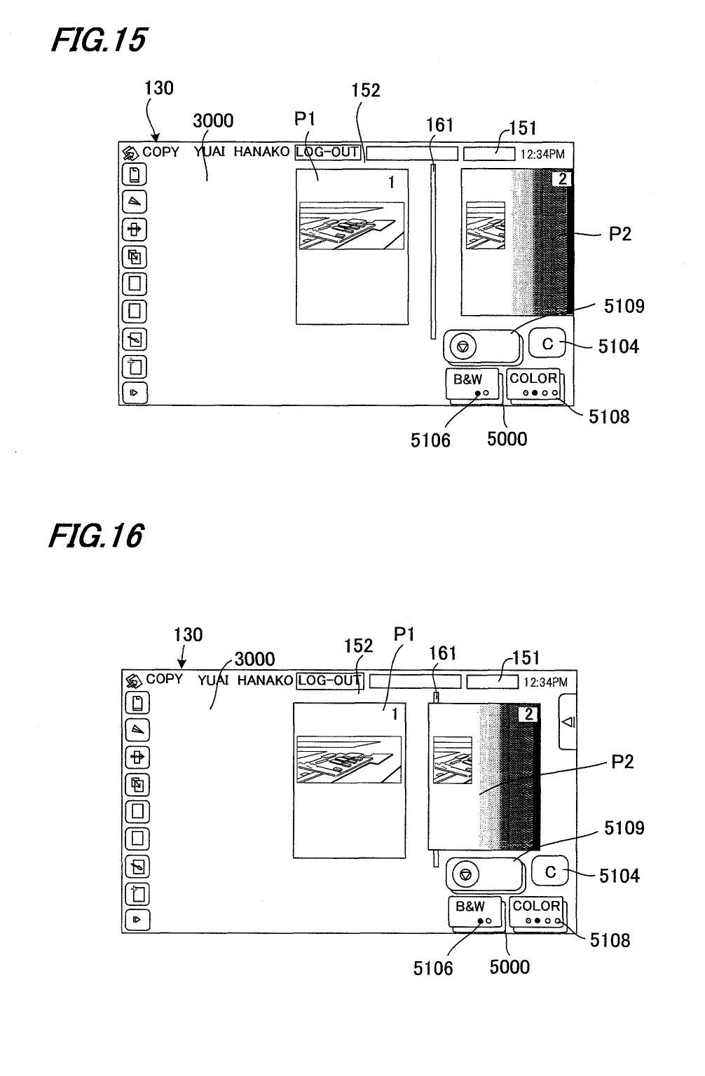

FIGS. 11 to 20 are illustrative views showing the progress of preview images displayed on touch panel display 130 at the time of document reading.

In image forming apparatus 100, when documents to be copied are read, the user selects the copy mode in the home screen displayed on touch panel display 130 and touches scan-in key 5102 as shown in FIG. 11 to start document reading.

The set documents are assumed to be A4 size documents in long-edge-feed orientation, for example.

When document reading is directed through scan-in key 5102, the displayed information of function selecting region 2000 (FIG. 11) and action panel region 4000 (FIG. 11) on touch panel display 130 is pulled in to both the left and right sides indicated by the arrows in FIG. 12 while preview region 3000 is expanded and border line 161 indicating the boundary between first display area 151 and second display area 152 formed in preview region 3000 is displayed. This border line 161 is to schematically represent the status of documents being scanned by document reader 102, on touch panel display 130, and will be referred to as “reading line”.

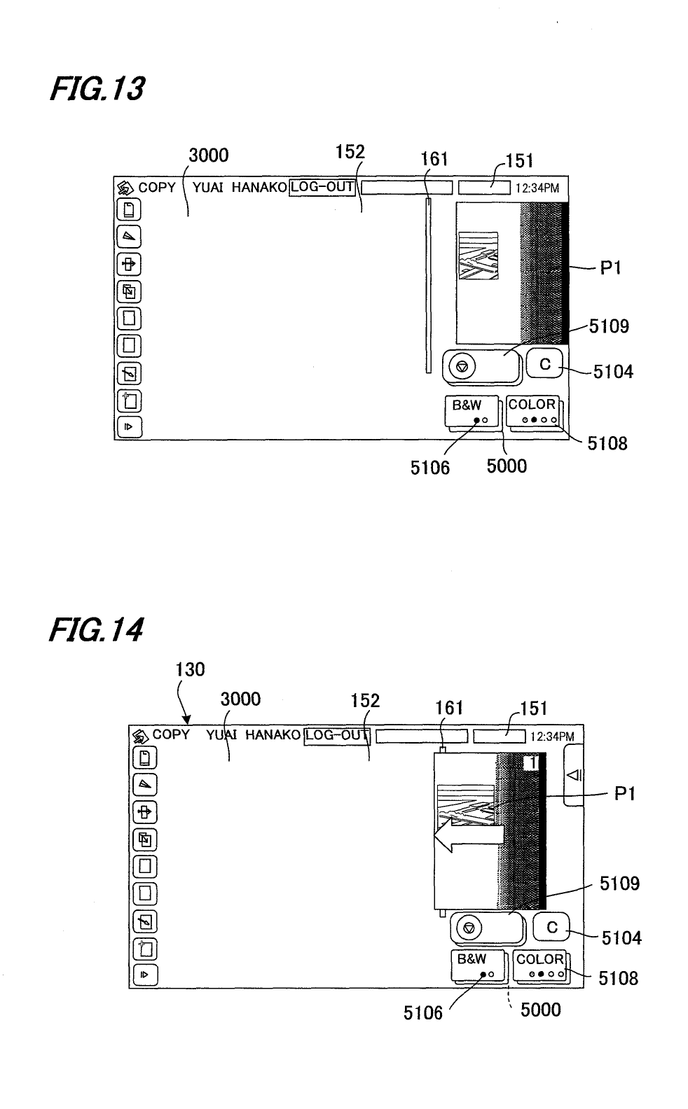

When documents are read by document reader 102, a preview image reduced in size by display image generator 137 is formed from the image data of the first scanned document, and the first sheet image P1 in its unclear state is displayed in first display area 151 on the right side of reading line 161, as shown in FIG. 13.

That is, the first sheet image P1 displayed in first display area 151 is displayed so as to gradually become clearer toward second display area 152 or reading line 161 (from right to left).

The first sheet image P1 displayed in first display area 151 moves toward reading line 161 whilst gradually becoming clearer as shown in FIG. 14 and passes over reading line 161 to second display area 152 on the left side of reading line 161, where the image is displayed clearly.

At this point of time, the second sheet image P2 formed from the image data of the second sheet document scanned by document reader 102 by display image generator 137 is reduced in size and displayed in an unclear state.

That is, the second sheet image P2 displayed in first display area 151 is displayed so as to gradually become clearer toward second display area 152 or reading line 161 (from right to left).

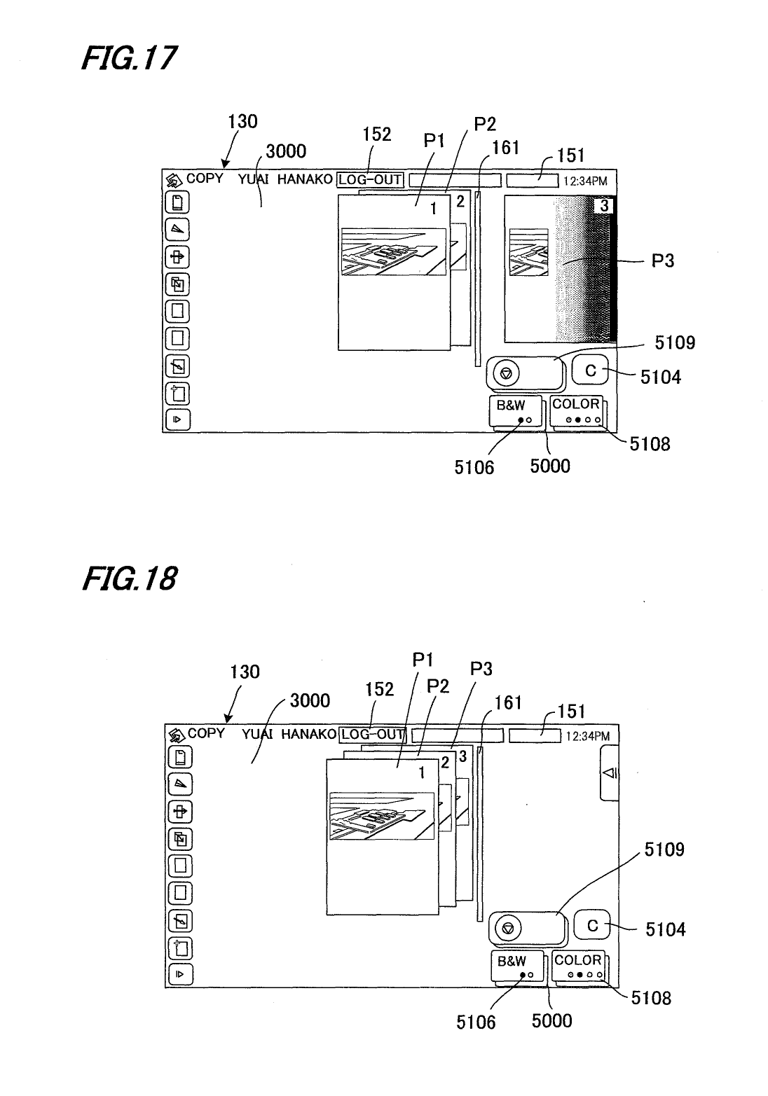

Then, the second sheet image P2 displayed in first display area 151 moves toward reading line 161 whilst gradually becoming clearer as shown in FIG. 16 and passes over reading line 161 to second display area 152 on the left side of reading line 161 as shown in FIG. 17, where the image is displayed.

At this point, the second sheet image P2 is laid behind first sheet image P1 with part of it exposed from the first sheet image 21 so as to have the existence of second sheet image P2 recognized.

Then, at this point of time, the third sheet image P3 formed from the image data of the third sheet document scanned by document reader 102, by display image generator 137 is reduced in size and displayed in an unclear state.

That is, the third sheet image P3 displayed in first display area 151 is displayed so as to gradually become clearer toward second display area 152 or reading line 161 (from right to left).

Then, third sheet image P3 displayed in first display area 151 moves toward reading line 161 whilst gradually becoming clearer as shown in FIG. 18 and passes over reading line 161 to second display area 152 on the left side of reading line 161, where the image is displayed.

At this point, the third sheet image P3 is further laid behind second sheet image P2 with part of it exposed from the second sheet image P2 so as to have the existence of third sheet image P3 recognized.

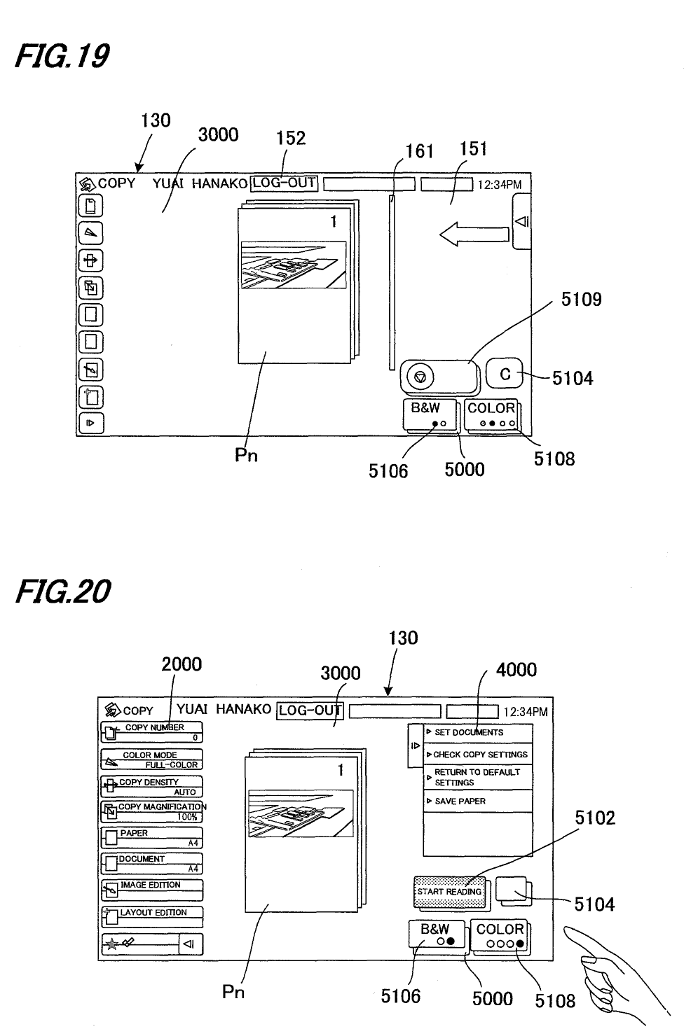

When display and movement of each preview document image of the document scanned by document reader 102 is repeated as described above and pre-scanning of all the documents by scan-in is completed as shown in FIG. 19, display of function selecting region 2000 and action panel region 4000 is restored while reading line 161 is deleted as shown in FIG. 20.

In the way, it is possible for the user to readily confirm the status of documents scanned by document reader 102 through touch panel display 130. Therefore, the user can easily perform function selection while confirming a bundle of images Pn (FIG. 19) displayed in preview region 3000. Further, the user can readily give instructions for addition scanning if necessary and instructions to start copying operation.

As has been described heretofore, image forming apparatus 100 is configured such that touch panel display 130 of control unit 120 is provided with first display area 151 for displaying a display image generated based on the input image data and second display area 152 for displaying the display image that was displayed in first display area 151 after its display in first display area 151, whereby the document image scanned by document reader 102 is displayed first in first display area 151, then transferred to second display area 152 and displayed. As a result, it is possible for the user to readily confirm the status (progress) of document reading by document reader 102 from touch panel display 130. Further, if display panel 132 with high definition is used, the user is able to grasp the detailed status (progress) of document reading, so that it is possible to improve the operativity of the touch panel display.

Though, in the present embodiment, to provide the display images on touch panel display 130, first display area 151 and second display area 152 are laid out side by side in the horizontal direction, the positional relationship between first display area 151 and second display area 152 is not limited to this.

Next, variational display mode examples of touch panel display 130 will be presented.

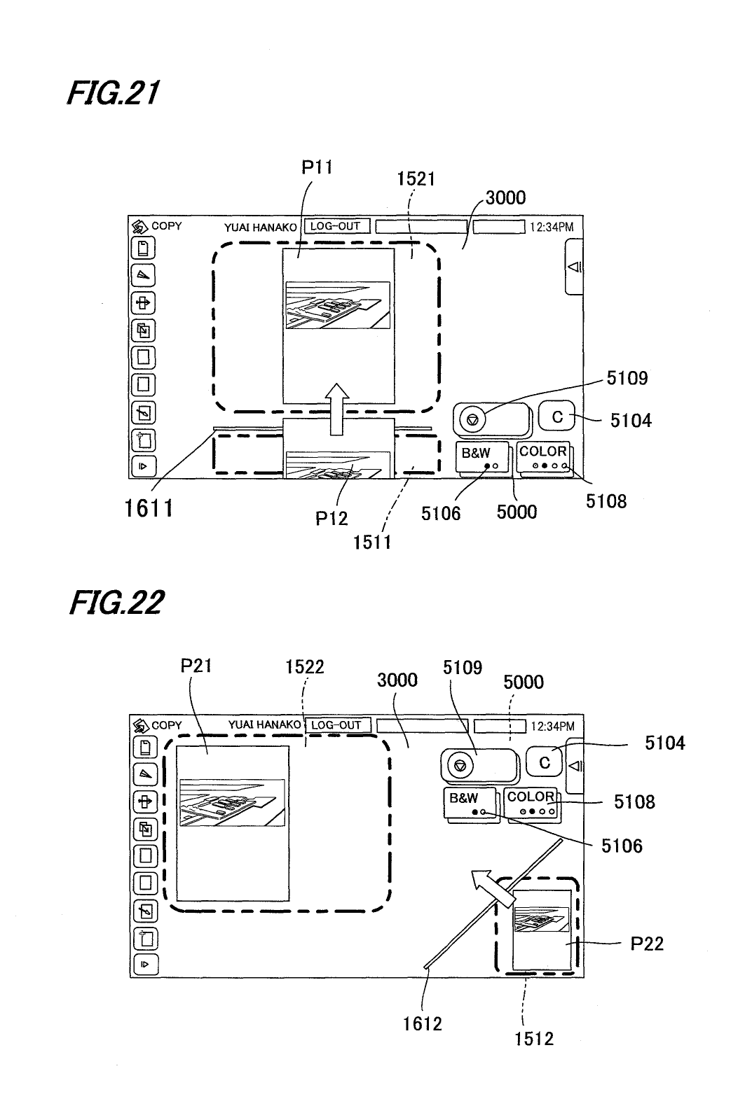

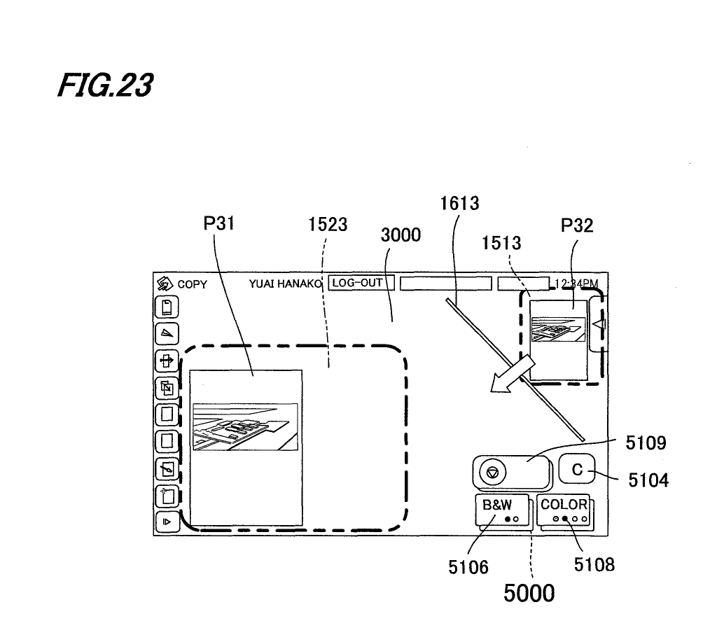

FIG. 21 is an illustrative view showing a variational example 1 of display mode of the touch panel display. FIG. 22 is an illustrative view showing a variational example 2 of display mode of the touch panel display. FIG. 23 is an illustrative view showing a variational example 3 of display mode of the touch panel display.

### Variational Example 1

A touch panel display 1301 of variational example 1 includes a similar configuration to that of touch panel display 130, in which a first display area 1511 is formed in the lower center of preview region 3000 while a second display area 1521 is formed in the approximate center of preview region 3000, as shown in FIG. 21.

A reading line 1611 that extends linearly in the horizontal direction is displayed between first display area 1511 and second display area 1521 so as to indicate the boundary between the two areas.

A document image P11 (FIG. 21) scanned by document reader 102 (FIG. 9) is displayed so as to move upwards from first display area 1511 toward second display area 1521. Then, a next document image P12 scanned by document reader 102 is displayed in first display area 1511.

With the above configuration, it is possible to produce the same effect as in the above-described embodiment.

### Variational Example 2

A touch panel display 1302 of variational example 2 includes a similar configuration to that of touch panel display 130, in which a first display area 1512 is formed in the lower right part of preview region 3000 while a second display area 1522 is formed in the upper left of preview region 3000, as shown in FIG. 22.

A reading line 1612 that linearly extends and inclines upwards and rightwards is displayed between first display area 1512 and second display area 1522 so as to indicate the boundary between the two areas.

A document image P21 scanned by document reader 102 is displayed so as to be enlarged as it is moving upwards and leftwards from first display area 1512 toward second display area 1522. Then, a next document image P22 scanned by document reader 102 is displayed in first display area 1512.

With the above configuration, it is possible to produce the same effect as in the above-described embodiment.

### Variational Example 3

A touch panel display 1303 of variational example 3 includes a similar configuration to that of touch panel display 130, in which a first display area 1513 is formed in the upper right part of preview region 3000 while a second display area 1523 is formed in the lower left of preview region 3000, as shown in FIG. 23.

A reading line 1613 that linearly extends and inclines downwards and rightwards is displayed between first display area 1513 and second display area 1523 so as to indicate the boundary between the two areas.

A document image P31 scanned by document reader 102 is displayed so as to be enlarged as it is moving downwards and leftwards from first display area 1513 toward second display area 1523. Then, a next document image P32 scanned by document reader 102 is displayed in first display area 1513.

With the above configuration, it is possible to produce the same effect as in the above-described embodiment.

Though the above variational examples illustrate configurations in which the display image is moved from the bottom to top or from right to left, the positional relationship between first display area and the second display area may be varied to any possible form because documents may be set on the right or left side depending on the configuration of the document reader (inclusive of an automatic document feeder).

The above embodiment was described taking examples in which control unit 120 is applied to image forming apparatus 100 shown in FIG. 1. However, as long as it is an image forming apparatus that includes a control unit capable of presenting document images in preview representation on the display panel or the like before printing, the invention can be developed to any other image forming apparatus and the like, not limited to the image forming apparatus and copier having the configuration described above.

Having described heretofore, the present invention is not limited to the above embodiments, various changes can be made within the scope of the appended claims. That is, it is apparent that various kinds of variations and modified examples will occur to those skilled in the art within the scope of the appended claims. That is, any embodied mode obtained by combination of technical means modified as appropriate without departing from the spirit and scope of the present invention should be included in the technical art of the present invention.

What is claimed is:

1. An image forming apparatus comprising:
an input unit receiving image data;
a storing unit storing the image data input from the input unit;
a display image generator generating a display image based on the image data stored in the storing unit;
a display unit displaying the display image generated by the display image generator; and,
a display controller for giving guidance on the input status of the image data input from the input unit, on the display unit, characterized in that
the display unit includes:
a first display area that displays the display image generated by the display image generator; and
a second display area that displays the display image that was displayed in the first display area after display thereof in the first display area, and
the display controller performs control so as to display the display image in the first display area when the display image is generated by the display image generator, and performs control so as to move the display image that was displayed in the first display area, toward the second display area and then display the display image in the second display area.

2. The image forming apparatus according to claim 1, wherein the display unit includes a preview display region that displays the finished state of the image based on the image data in a preview representation, as the display image, and the second display area is formed within the preview display region.

3. The image forming apparatus according to claim 1, wherein the display controller performs control so that when the display image is displayed in the first display area, the display image becomes gradually clearer toward the second display area and so that when the display image that was displayed in the first display area is moved to the second display area, the display image that is depicted clearly is displayed whilst it is being moved.

4. The image forming apparatus according to claim 1, wherein the display controller displays a border line at the boundary between the first display area and the second display area and performs control such that when the display image that was displayed in the first display area is moved toward the second display area, the display image is moved passing over the border line.

5. The image forming apparatus according to claim 1, wherein the input unit is a scanner portion that reads the image of a document to output the image data, and,
the display controller gives guidance on the input status of reading the document images, on the display unit when the display images have been generated based on the scanned image data of the documents read by the scanner unit.

6. The image forming apparatus according to claim 1, wherein the display unit includes a command control portion that enables the user to designate the function settings in image forming of the documents displayed as the display image on the display unit, and makes the command control portion appear near the display image when display of the input status of the image data by the display controller has been completed.

7. The image forming apparatus according to claim 2, wherein the display unit displays the preview display region in an enlarged size when input of the image data is commanded.

8. The image forming apparatus according to claim 7, wherein the display unit has a control key region including control keys associated with the operation of the apparatus, and the control key region will not be reduced in size when the preview display region is displayed in an enlarged size.

9. The image forming apparatus according to claim 8, wherein the border line and the control key region are laid out closely to each other in the display unit.

10. The image forming apparatus according to claim 8, wherein an interrupt key for interrupting the operation of the apparatus is provided in the control key region of the display unit.
